(19) United States
(12) Patent Application Publication
(10) Pub. No.: US 2008/0263632 A1
(43) Pub. Date: Oct. 23, 2008

(54) System and Method for Managing Use and Access of a Communication Network

(76) Inventor: Neil Keon, Dallas, TX (US)

Correspondence Address: KING & SPALDING LLP, 1180 PEACHTREE STREET, ATLANTA, GA, 30309-3521, US

(21) Appl. No.: 11/665,913

(22) PCT Filed: Oct. 20, 2005
(86) PCT No.: PCT/CA2005/001613

§ 371 Date: Mar. 7, 2008

Related U.S. Application Data
(60) Provisional application No. 60/620,605, filed on Oct. 20, 2004.

(51) Int. Cl. G06F 21/00

(52) U.S. Cl. 726/3

(57) ABSTRACT

The present invention provides a system and method for managing access and use of a communication network or service or service. When a user requests the use of a communication network or service and this network is experiencing a level of use which is above a predetermined threshold, one or more incentives can be offered to the user in return for deferring access to the communication network or service for a predetermined period of time. In this manner, usage of the communication network or service can be managed such that variability of the usage level over time can be reduced.

### FIELD OF THE INVENTION

The present invention pertains to a system and method of managing the use and access to a communication network or service that improves network service availability by offering deferred service consumption.

### BACKGROUND

Revenue management that improves the performance of real-time service systems where there is no possibility of advance reservations is a challenge. Currently services are assumed to be purchased at a bulk rate per subscription or prepaid at a fixed rate or charged at a fixed rate that is known in advance of the session, for example as is common in mobile telephony.

The routing of mobile or line based voice or data services is schematically illustrated in FIG. 1 for the caller and FIG. 2 for the answerer. The routing comprises the following briefly summarized steps: The user initiates a call request via a user device which sends a request signal to the network to set up a session with at least one other user or device. If the network has sufficient resources available to establish a session, then the other users are notified who decide to accept or reject the incoming call. If the other users accept the incoming call an acknowledge signal is returned to the user device through the network. If the other users reject the call then the session terminates. The user or the other users can end a session by submitting an end call event. This allows the network to release any resources that were allocated for the session.

Many present communication network or service networks suffer from limitations in accessing the network, for example, when the network operates near full capacity then access to the network or service is frequently unavailable for additional users, i.e. high blocking rates are observed. Besides improving the network capacity, a number of solutions provide economical incentives for users to delay the consumption of communication network or services and temporarily shift demand to times of lower network load. However, all currently known other solutions are ineffective in deciding on award incentives at the time a service is requested.

Therefore there is a need for a new system and method for managing use and access to a communication network or service.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a system and method for managing use and access of a communication network. In accordance with an aspect of the present invention, there is provided a system for managing use and access to a communication network or service, said system comprising: one or more user devices adapted for connection to the communication network or service, each of said user devices having a deferral management system installed thereon, each said deferral management system for regulating and controlling access to the communication network or service by a respective user device; and a deferral assessment system adapted for evaluating usage of the communication network or service, said deferral assessment system for generating access data reflective of the usage of the communication network or service; wherein said deferral management system regulates and controls access of the respective user device to the communication network or service in response to the access data.

In accordance with another aspect of the invention, there is provided a method of communication network access comprising the steps of: offering a subscriber attempting access to the network a reward for deferring access by a predetermined delay; providing the award on acceptance by the subscriber; and accepting access from the subscriber after at least the predetermined delay.

In accordance with another aspect of the invention, there is provided a method of communication network access comprising the step of: establishing an access queue having current access and deferred access subscribers.

In accordance with another aspect of the invention, there is provided a method of accessing a communication network comprising the steps of: establishing pools of subscribers having current access and deferred access; offering a subscriber attempting access to the network a reward for deferring access by a predetermined delay; providing the award on acceptance by the subscriber; and accepting access from the subscriber after at least the predetermined delay.

In accordance with another aspect of the invention, there is provided an apparatus for communication network access comprising: means for offering a subscriber attempting access to the network a reward for deferring access by a predetermined delay; means for providing the award on acceptance by the subscriber; and means for accepting access from the subscriber after at least the predetermined delay.

In accordance with another aspect of the invention, there is provided an apparatus for communication network access comprising: means for establishing an access queue having current access and deferred access subscribers.

In accordance with another aspect of the invention, there is provided an apparatus for accessing a communication network comprising: means for establishing pools of subscribers having current access and deferred access; means for offering a subscriber attempting access to the network a reward for deferring access by a predetermined delay; means for providing the award on acceptance by the subscriber; and means for accepting access from the subscriber after at least the predetermined delay.

In accordance with another aspect of the invention, there is provided a computer readable medium having recorded thereon statement and instructions for execution by a computer to carry out the method including the steps of: offering a subscriber attempting access to the network a reward for deferring access by a predetermined delay; providing the award on acceptance by the subscriber; and accepting access from the subscriber after at least the predetermined delay.

In accordance with another aspect of the invention, there is provided a computer readable medium having recorded thereon statement and instructions for execution by a computer to carry out the method including the steps of: establishing an access queue having current access and deferred access subscribers.

In accordance with another aspect of the invention, there is provided a computer readable medium having recorded thereon statement and instructions for execution by a computer to carry out the method including the steps of: establishing pools of subscribers having current access and deferred access; offering a subscriber attempting access to the network a reward for deferring access by a predetermined delay; providing the award on acceptance by the subscriber; and accepting access from the subscriber after at least the predetermined delay.

### BRIEF DESCRIPTION OF THE FIGURES

FIG. 1 illustrates the outgoing service request routing of mobile or line based voice or data services as it is known in the prior art.

FIG. 2 illustrates the incoming service request routing of mobile or line based voice or data services as it is known in the prior art.

FIG. 3 illustrates an embodiment of the system and method for managing use and access of a communication network.

FIG. 4 illustrates a logic diagram of the operation of an access and use management system according to an embodiment of the present invention.

FIG. 5 illustrates a finite state diagram with possible transitions between a finite number of states of parts of an embodiment of the access and use management system.

FIG. 6 illustrates a finite state diagram with possible transitions between a finite number of states of parts of an embodiment of the access and use management system.

FIG. 7a illustrates a flow diagram for a state of an embodiment of the system when an award is offered to a user who initiates an outgoing call.

FIG. 7b illustrates a flow diagram for a state of an embodiment of the system when an award is offered to a user who receives an incoming call.

FIG. 8a illustrates a flow diagram for a state of an embodiment of the system when interrupts occur during a pending agreement.

FIG. 8b illustrates a flow diagram for a state of an embodiment of the system when an incoming session request is received during a pending agreement.

FIG. 9a illustrates a flow diagram for a state of an embodiment of the system when no award is being offered to a user initiating a service request.

FIG. 9b illustrates a flow diagram for a state of an embodiment of the system when no award is being offered to the user receiving a service request.

FIG. 10 illustrates a wireless network architecture extended by embodiments of the access and use management system.

FIG. 11 illustrates the effect of demand resulting from free service in exchange for delayed service according to a model simulation of an embodiment of the present invention.

FIG. 12 illustrates a queuing model according to a model simulation of an embodiment of the present invention.

FIG. 13 illustrates simulated antenna availability in a deferred service setting according to a model simulation of an embodiment of the present invention.

FIG. 14 illustrates simulated antenna availability in a deferred service setting according to a model simulation of an embodiment of the present invention.

FIG. 15 illustrates optimal service according to a model simulation of an embodiment of the present invention.

FIG. 16 illustrates the resulting effect on demand for service according to a model simulation of an embodiment of the present invention.

FIG. 17 illustrates a queuing system model according to a model simulation of an embodiment of the present invention.

FIG. 18 illustrates a deferred service distribution according to a model simulation of an embodiment of the present invention.

FIG. 19 illustrates availability per amount of offered deferred service according to a model simulation of an embodiment of the present invention.

FIG. 20 illustrates policies and distributions that maximize availability and service throughput according to a model simulation of an embodiment of the present invention.

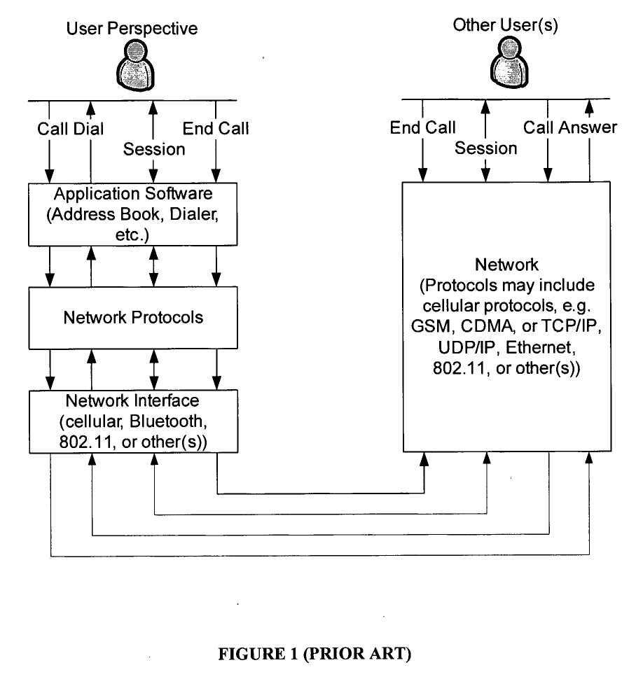

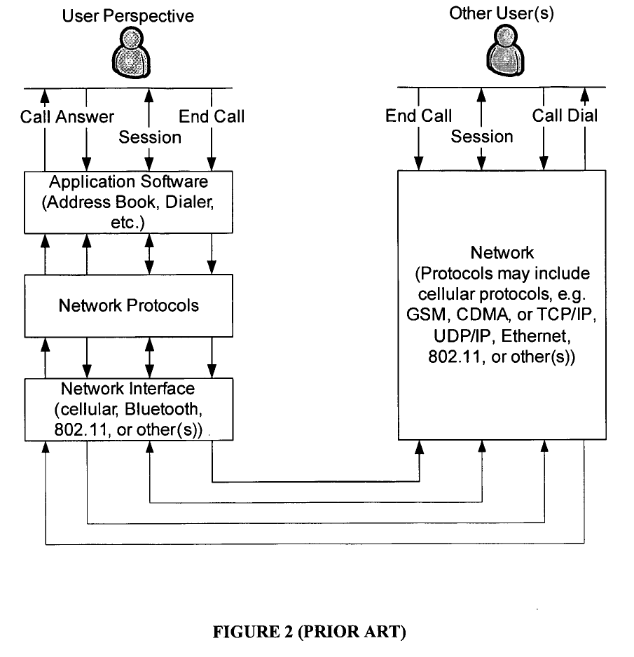

### DETAILED DESCRIPTION OF THE INVENTION

### Definitions

The conjunction “or” is used in its exclusive disjunctive form only in combination with the word “either”, otherwise “or” is always used in its inclusive disjunctive form.

Unless defined otherwise, all technical and scientific terms used herein have the same meaning as commonly understood by one of ordinary skill in the art to which this invention belongs.

The present invention provides a system and method for managing access and use of a communication network or service or service. When a user requests the use of a communication network or service and this network is experiencing a level of use which is above a predetermined threshold, one or more incentives can be offered to the user in return for deferring access to the communication network or service for a predetermined period of time. In this manner, usage of the communication network or service can be managed such that variability of the usage level over time can be reduced.

The access and use management system according to the present invention is enabled through two cooperating components which function in a symbiotic relationship and together enable use assessment of a communication network or service and management of a user's access to the communication network or service. The first component, the deferral management system, is installed on each user device which employs this system, and this component controls the user's access to the communication network or service in response to information provided by the deferral assessment system. The deferral assessment system evaluates usage levels of the communication network or service and evaluates an incentive or award to be presented to the user for deferral of access to the communication network or service. The deferral assessment system relays the determined incentive or award to the to the user device, specifically the deferral management system, wherein the user's acceptance of an award results in a deferral of their access to the communication network or service. The deferral assessment system together with the deferral management system can thereby create a queue for access to the communication network or service and thereby manage the level of use of the communication network or service. In the event that a user declines a present incentive or award, the deferral management system can initiate or complete the user device's access to the communication network or service.

The access and use management system according to the present invention can be configured to operate in association with a plurality of different communication network or services, wherein any communication network or service comprises a plurality of layers which provide for the communication between two user devices. The access and management system can be configured as an intermediate connection layer between the user device and a communication network or service. This intermediate connection layer comprises the deferral management system and the deferral assessment system, wherein this intermediate layer performs the required functions prior to the subsequent layers of the communication network or service. In this manner, the deferral management system together with the deferral assessment system can generate a queue for communication access.

The access and use management system according to the present invention extends the classical direct service access by controlling the user's access to communication network or services in return for deferred service awards. The award can range from free or reduced cost for service or some other award for accessing or consuming communications services, for example digital music, online banking in return deferred use for a defined time.

The access and use management system maintains one or more queues of user service requests and controls user access to the communications network. The access and use management system resolves user requests upon acceptance of a service offer by the user by connecting the user to the requested service at a time as specified in the offer at which time the access and use management system releases access to the service and no longer controls user access to the service until a termination event. Termination events can be initiated by the user or they can be inherent to the service, for example, the user hangs up on a voice connection or the communication network or service has a final duration, for example with digital video or music downloads.

The access and use management system can administer service requests from one or more users. The users submit service requests via a user device through data links into the communications network and services can be provided through the same or a different data link than the one that was used for requesting the service. A geographical area can be covered by one or more data links, for example, wired network connections or wireless network cells. Examples for wired and wireless connections or cells are well known to someone skilled in this art. Data links can be wireless or wired connections. The rate at which user requests can be accepted by the system is limited by the system's data throughput and can be limited by a number of reasons, for example, the number of physically possible communications connections per data link or the bandwidth of other portions of the communications network.

The access and use management system and method may also effective for purchases that could be made one at a time, for example video clip downloads, or music downloads.

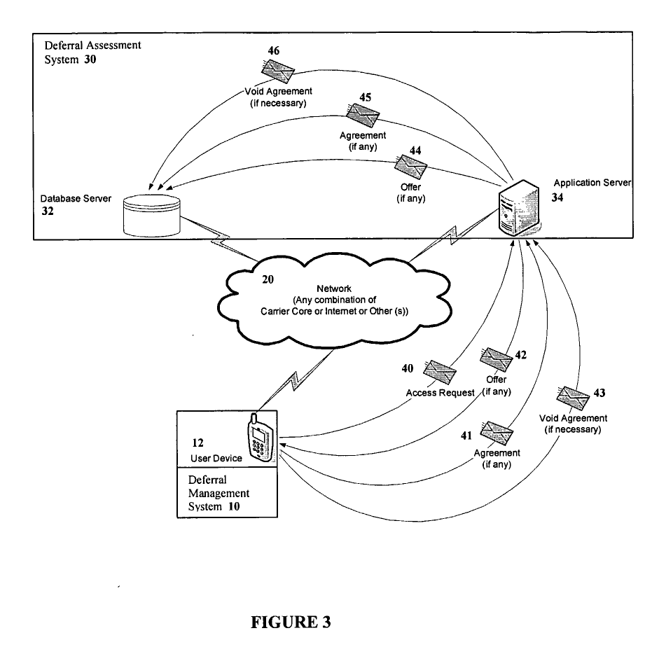

With reference to FIG. 3, one embodiment of the system according to the present invention is illustrated. The system comprises a user device 12, which is configured to enable access to the communication network or service 20. The user device has installed thereon a deferral management system that controls or manages the access of the user device to the communication network or service. The deferral management system communicates the deferral assessment system and initiates the determination of a potential incentive or award that may be provided for the deferment of access to the communication network or service. The deferral assessment system comprises one or more computational devices for example application servers, which provide this system with its functionality, namely evaluation of the load of the communication network or service and the evaluation of whether a suitable incentive or award can be offered to the user. The deferral management system initiates the access of the user device to the communication network or service, wherein this initiation of access is dependent on whether an incentive or award has be offered and if necessary the user's response to the offered incentive or award.

For example, as illustrated in FIG. 3, the user device 12, via the deferral management system 10 requests access to the to the communication network or service 20, wherein this request 40 is transmitted to the deferral assessment system 30. The deferral assessment system subsequently evaluates the current status of operation of the communication network or service and may determine if an offer is to be presented. In the event that an offer is determined, the offer 42 is transmitted to the deferral management system 10 for review by the user, wherein upon acceptance of the offer by the user, an agreement notice 41 can be transmitted back to the deferral assessment system and a predetermined period of delay can be initiated. Upon the passage of this predetermined period, the user device can access the communication network or service and the user will be provided with the agreed upon incentive or award. In the event that the user initiates access to the communication device prior to the passage of the predetermined period, the user can optionally void the agreement wherein a void notice 43 can be sent to the deferral assessment system. As illustrated in FIG. 3, the deferral assessment system can store for example in a database 32, selected or all interactions 46, 45, 44 with the deferral management system for subsequent use or evaluation.

In one embodiment, the deferral management system may transmit the agreement notice 41 and the void notice 43 can be sent directly from the deferral management system 10 to the database 32, for example. This scenario may be suitable if the database is located at a separate location when

FIG. 3 illustrates a single user device 12, however it would be readily understood by a worker skilled in the art that the system may comprise a plurality of user devices with each user device having a deferral management system 10 installed thereon. Furthermore, it would be readily understood that the database server 32 may be positioned at a location proximate to the application server 34, integrated with the application server 34 as a single computing device or positioned at a separate location from the application server 34. Depending on the configuration of these components a suitable format of communication therebetween can be initiated if required, for example a local area network or a public accessible network, internal machine communication or other information transmission configuration.

### User Device

Users can use the method as implemented in the system according to the present invention through user devices. User devices can be fixed wired or mobile wireless communication devices, for example, computer consoles, classical phones, paging devices, cell phones or personal digital assistants (PDAs). The user device can be any existing or new cell phone which has configurable components and the capacity to implement the method. For example, the configuration can take place by extending the programming of the cell phone firmware. User devices can be configured to operate via any combination of wired or wireless carrier media including the simultaneous uplink and downlink on separate media. Consequently, user devices require adequate interfaces for connecting to these media, for example, antennae or sockets and respective drive systems for operating the interfaces.

The present method and system can be integrated into many existing kinds of user devices. Most user devices comprise configurable embedded control systems for controlling the user device and the method can be implemented in software or firmware in an embedded control system, for example, via refurbishing the user device or proper configuration of newly manufactured user devices. The present invention can also be implemented in hardware. Implementation of a access and use management system requires a user device with a deferral management system for enabling the method on the user device. Note that a access and use management system also comprises a deferral assessment system which can be spatially or geographically distributed and accessible via parts of communication network or services.

The deferral management system can be implemented as a functional extension to an existing user device and as such requires modification of the control system in the user device. For example, the deferral management system needs to interact with a number of user device components to be able to transparently submit service requests, receive award status information, present the information in the award status, interact with the user, control certain aspects of the user device that are available to the user during service deferral, and release control over the user device functionality otherwise.

### Deferral Management System

A deferral management system is installed on each user device associated with the system according to the present invention. The deferral management system provides a means for managing the ability of a user device to access a communication network or service. The deferral management system provides a means for controlling the time at which the user device upon which it is installed, accesses the communication network or service.

The deferral management system is configured to initiate communication with the deferral assessment system upon a request for access to the communication network or service, for example the dialing of a telephone number. The deferral management system together with the deferral assessment system can provide options relating to the time at which the user device accesses the communication network or service.

Upon the completion of the interaction between the deferral management system and the deferral assessment system, the access of the user device is not affected or controlled by the deferral assessment system. In one embodiment of the present invention, for a particular request for access to a communication request, once the deferral management system completes it protocol, it terminates its interaction with the user device thereby not impeding or managing the access of the user device to the communication network or service.

In one embodiment of the present invention, the deferral management system is further configured to provide an indication to the user that the predetermined time period previously agreed to has passed and therefore the user can initiate access of the communication network or service. In this manner, the user can be immediately identified when access is permitted while still receiving the agreed upon incentive or award. For example, the user device can produce an audible, visual or vibrational indication of the passage of the predetermined period time.

In one embodiment of the present invention, the deferral management system monitors the time required for the deferral assessment system to provide an offer upon the initial sending of an access request thereto. For example, if a predetermined period of time has lapsed and an offer has not been received by the deferral management system, the user device would be given permission to access the communication network or service.

In one embodiment of the present invention, the deferral management system is configured in the form of a module that can be integrated into a user device. In this manner the deferral management system can be inserted into an appropriate slot in the user device for subsequent activation by the user device upon the initiation of access to a communication network or service. For example, the module can be formed as a chip, wherein the coding for the operation of the deferral management system is configured as firmware or hardwired into the module for example. A worker skilled in the art would readily understand how to configure a module for integration into a user device, wherein the configuration of the module can be modified in order to be accepted by a particular user device. For example, the deferral management system module specifically designed for a cellular phone may be different from a module that would be appropriate for a personal digital assistant.

In another embodiment of the present invention, the deferral management system is configured as code means for example a program, wherein this program can be downloaded from a network into user device memory, loaded from a memory storage device in to user device memory or flashed into user device memory, for example. Alternate modes of installation of the code means into memory of a user device would be readily understood by a worker skilled in the art.

In an alternate embodiment of the present invention, the deferral management system and the user device are integrated as a single device specifically designed for use with the system according to the present invention. This configuration of the user device with integrated deferral management system may be optimized for use and operation with the present invention.

In one embodiment of the present invention, each deferral management system has a unique identifier associated therewith, thereby providing a means for the deferral assessment to identify specific user devices and subsequently the users thereof, for example.

### Deferral Assessment System

The deferral assessment system comprises one or more computing devices which are configured to evaluate the usage of a communication network or service to which access can be requested by a deferral management system installed on a user device. The deferral assessment system further provides a means for the determination of an incentive or award that can be presented to the user device for delaying the time at which it accesses the communication network or service.

The format of the incentive can be anything that can have a perceived value to a particular user. For example, an incentive can be equal to or more valuable to a user than the period of time which their access to the communication network or service is deferred. For example an incentive or award can be money, discounts, fee usage time, free downloads, or any other type of incentive that can have a perceived value to a user, as would be readily understood by a worker skilled in the art.

In one embodiment of the present invention, the deferral assessment system evaluates the type of incentive or award based on a comparison between the evaluated usage level of the communication network or service and a predetermined threshold. For example, if a request is received and the evaluated usage level is below a predetermined threshold, an incentive will not be presented. When the evaluated usage level is above a predetermined threshold, the incentive can be determined based on the deferral period required for example. In one embodiment of the present invention, the determination of the incentive or award can be personalized to the user of the user device requesting access to the communication system.

In one embodiment, based on the usage history of communications services by the users or the communications network capacity at one or more determined points in time, service prices or incentives can be determined according to a pricing model.

In one embodiment of the present invention, the deferral assessment system actively monitors the status of usage of the communication network or service. Alternately, the deferral assessment system can comprise a model representing network usage levels. This model can be periodically redefined based on actual monitored levels of usage of the network, for example.

The functionality of the deferral assessment system can be provided by one or more computing devices. The number of computing devices forming the deferral assessment system can be directly dependent on the number of deferral management systems installed on user devices, in this manner the required computation power of the deferral assessment system can be determined based on an expected number of access requests that will be received from the deferral management systems taking into account the desired time for response to the access requests. For example, the deferral assessment system can be configured in a manner such that it is capable of providing responses to request in real time.

The deferral assessment system is configured for connection to the communication network or service and additionally configured for communication with the one or more deferral management systems. In one embodiment, the communication between the one or more deferral management systems and the deferral assessment system can be enabled using the communication network or service or optionally can be enabled using a secondary communication network or service which can be provided for intersystem communication only, for example.

In one embodiment the deferral assessment system comprises one or more databases, which can provide a means for storing information relating to the interactions between a plurality of deferral management systems and the deferral assessment system. The database can further comprise information relating to a user's identity for a specific user device, thereby enabling the potential of correlating users with their previous interactions with the deferral assessment system.

In one embodiment of the present invention, the deferral assessment system can access the database in real time thereby providing a means for the determination of a personalized incentive with respect to the specific user requesting access to the communication network or service. This personalization of the incentive can be based on prior history of interactions of the user with the access and use management system, and can also be based on user preferences which may additionally be stored in the database.

In one embodiment the deferral assessment system comprises a plurality of computing devices, wherein the operation of these computing devices can be regulated using a dynamic allocation protocol. For example, upon receipt of a request for access by a deferral management system, this request can be dynamically allocated to the computing device that is least active. This form of dynamic allocation of available resources can provide a means for enhancing the efficiency of the deferral assessment system. Furthermore, using this format of dynamic operational allocation of tasks can provide a means for the addition of additional computing device to the deferral assessment system as required, with minimal impact on the operation of the deferral assessment system.

In one embodiment a single deferral assessment system can be provided for use with an entire communication network or service.

In an alternate embodiment, a global deferral assessment system can comprise a plurality of regional deferral assessment systems, wherein a regional deferral assessment system can provide the desired level of functionality to a particular region of the communication network or service, while the global deferral assessment system provides control parameters to the regional deferral assessment systems. In this configuration, the user devices can be configured to send access requests to a defined regional assessment system, and the regional assessment system can communication with the global deferral assessment system. In this manner the number of communicational interactions with the global assessment system may be reduced.

In one embodiment of the present invention, the computing device and the database of the deferral assessment system can be integrated into a single unit. Optionally the database can be located at a different location from the deferral assessment system.

### Communication Network or Service

Carrier media can be any combination of material or vacuum and electromagnetic waves. User devices can be configured to use any combination of cell phone network, WiFi™, Bluetooth™, or other wired or wireless network technology and can include classical wired voice and data networks such as public switched telephone networks (PSTN), for example. Voice and data transfer can be accomplished via IP or alternative protocols and can be based on many different transport protocols such as Ethernet or ATM, for example. Such user device and communication network technology is well known in the art and references can be found, for example in the Open Systems Interconnection Reference Model. The access and use management system can be implemented using a number of different application layer protocols.

The communication network provides the link between user devices and service providers. The deferral assessment system can be operated by service providers and it can be viewed as a relay system that controls user access to communication services. The present invention can be used in any portion of a communication network that can provide links between two or more users. Such network links can comprise homogeneous or heterogeneous but linked network technologies. The network can include terrestrial or extraterrestrial, for example satellite links, components.

The method and system of the present invention can cause additional network traffic which can be distributed over time in order to achieve a more balanced load of the communication network. For various reasons, fast response and low latency in consequence of service requests in communication networks can be a more critical network requirement in order to be able to provide acceptable usability experience to the user when using the services of the access and use management system. In consequence, the network latency requirements may be increased when the use of access and use management system is desired. Similar latency requirements are imposed on the deferral assessment system. The access and use management system requires communication networks architectures that can meet certain quality of service guarantees.

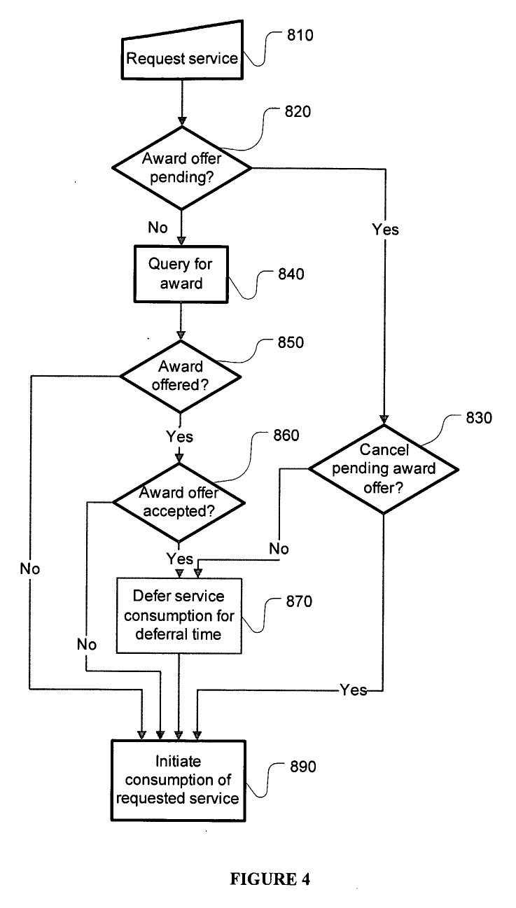

FIG. 4 illustrates a logic diagram of the operation of the access and use management system according to one embodiment of the present invention. In step 810 a user requests a service and subsequently in step 820 it is decided whether the system determines if an award offer is currently pending. If an award offer is pending a user notification is placed (not illustrated) and in step 830 it is determined whether to cancel the pending award offer. If the pending award offer is cancelled, a consumption of the requested service can be initiated in step 890. Alternatively, the instant service request can be queued for an award query in step 840 (not illustrated) and subsequently processed as indicated in FIG. 4. If the pending award offer is not cancelled, the method and system will initiate consumption of the pending award offer as originally scheduled and can discard the instant service request or the instant service request can be queued for an award query in step 840 (not illustrated) and subsequently processed as indicated in FIG. 4.

If no award offer is pending in step 820, the access and use management system places a query for an award offer in step 840. Subsequently, if an award is offered in step 850 within a predetermined amount of time, the award offer is presented (not illustrated) and if it is accepted in step 860, the request for service as placed in step 810 is scheduled for deferred consumption in step 870. Note that the award offer can comprise a certain price to consume the requested service within a certain time. If no award is being offered in step 850 or no award offer is being made within a predetermined amount of time, consumption of the requested service is initiated in step 890. Additionally, if an award offer is presented (not illustrated) but not accepted in step 860, consumption of the requested service can be initiated in step 890.

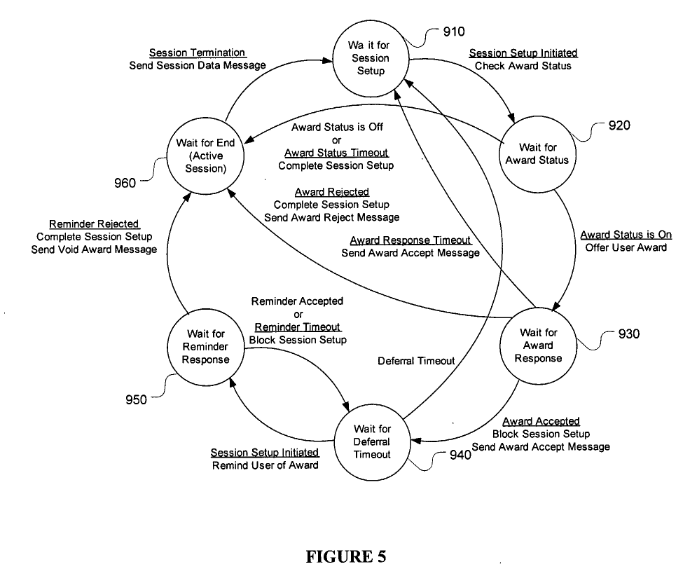

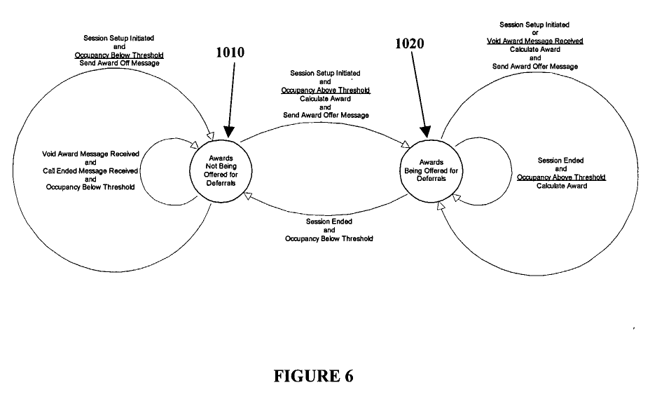

FIG. 5 and FIG. 6 illustrate possible transitions between a finite number of states of the access and use management system which are identified by circles. The method can be implemented in a spatially or geographically distributed system and it comprises the user devices, the deferral management system and the deferral assessment system. The deferral assessment system comprises one or more application servers and one or more database servers. The system can assume one of the states as illustrated in each of FIG. 5 and FIG. 6 at a time, i.e. two states, one on each figure or one on each side of the system transmission(s). System events can cause the system to go through transient reconfiguration between states. A system event can be a service request which can originate from anywhere within the network. Transient reconfigurations in FIG. 5 are identified by text labelled arrows. Labels have horizontal lines. Any text within a label above a solid horizontal line indicates the causes of an event, and any text in the label below the line indicates the actions in response to the respective event.

FIG. 5 illustrates the states of the deferral management system and FIG. 6 illustrates the states of the deferral assessment system. All communication between the components of the system employs a predefined communication protocol for example between the application servers and database servers.

The deferral management system as illustrated in FIG. 5 can detect service request events, for example, an outgoing call or an incoming call. If the system is in “Wait for Session Setup” state 910 the deferral management system triggers a “Check for Award Status” and changes into the “Wait for Award Status” state 920. The “Check for Award Status” event can request an award offer from the deferral assessment system or the deferral management system can have been previously updated by the deferral assessment system to offer certain awards. The system remains in the “Check for Award Status” state 920 either until the system receives or detects an “Award Status is On” or an “Award Status is Off” event. In large networks it may be advantageous for the deferral assessment system to broadcast award offers or updates on the award offers to the deferral management system when the deferral assessment system recognizes award changes as an effect of its award policy. In the latter case the deferral management system does not need to query an award status from the deferral assessment system.

The deferral management system can change from the “Wait for Award Status” state 920 in a number of ways. If an “Award Status is On” event occurs the system notifies the user and presents the award offer and changes into the “Wait for Award Response” state 930. If an “Award Status is Off” event occurs or if no award status information is received by the deferral management system within an award status timeout period, the deferral management system instructs the user device to complete the service request and initiate the session setup. The duration of the award status timeout can be tailored to meet a predefined usability experience for the requested communication network or service. The duration of award status timeouts can depend on the attention span, the expectations of a user and the service experience as perceived by the user.

The deferral management system can change from “Wait for Award Response” state 930 in three ways. If the user accepts the award offer, then the system changes into “Wait for Deferral Timeout” 940 and the deferral management system defers access to the requested service for a deferral time or time range as agreed per the award offer, for example five to ten minutes. During the “Wait for Deferral Timeout” state 940 the deferral management system can block or cancel further requests for the same service, for example, it can reject incoming calls or inhibit dialling or it can transmit information relevant to the additional request to the deferral assessment system. If the user does not respond to the Award Offer within a certain amount of time, the system changes into the “Wait for Session Setup” state 910 state and the expiry can be submitted for logging by the deferral assessment system. During the “Wait for Award Response” state 930 the user device can provide any combination of acoustic, visual, or tactile responses to indicate that it is awaiting a user response. If the user rejects the award offer the deferral management system instructs the user device to initiate the default session setup procedures resident on the device.

If the deferral time has elapsed the deferral management system changes from the “Wait for Deferral Timeout” state 940 to the “Wait for Session Setup” state 910 without requiring further user interaction. If the user places another service request, for example, the user attempts to initiate or accept a session setup while the system is in the “Wait for Deferral Timeout” state 940, the deferral management system will notify the user of the previously accepted agreement and change into the “Wait for Reminder Response” state.

The deferral management system can change from the “Wait for Reminder Response” state 950, for example, if the user completes the session setup, if the user rejects the award from the reminder, if the user abandons the additional service request or if the user reconfirms the pending award offer. The “Wait for Reminder Response” state 950 can be set to time out when the “Wait for Deferral Timeout” state 940 expires.

The session setup has been successfully completed in the “Wait for Session End” state 960. When a session terminates, the deferral management system can transmit information relevant to the terminated session for logging by the deferral assessment system.

The deferral assessment system as illustrated in FIG. 6 can manage a plurality of simultaneous service requests, for example, requests for outgoing calls or incoming calls. The deferral assessment system can assume a number of states of which “Awards Not Being Offered for Deferrals” state 1010 and “Awards Being Offered for Deferrals” state 1020 are illustrated in FIG. 6. In an embodiment of the present invention the system can change between the two states every time the network traffic exceeds or falls below a predefined threshold. Network traffic can be monitored directly or by inference, for example by maintaining records of active sessions. The latter works in embodiments of the present invention that collect, submit and record information about terminated sessions and require certain user device functionality. The deferral assessment system can change from “Awards Not Being Offered for Deferrals” and “Awards Being Offered for Deferrals” based on analysis of available user profile and network traffic information.

Service request events or “Void Award Offer” events can increase the network traffic. If the network traffic exceeds the predefined threshold subsequent user requests can be offered more incentive award offers depending on the amount by which the network traffic exceeds the threshold. In one embodiment of the invention, if network traffic falls below the predefined threshold, the deferral assessment system can broadcast a general “No Awards” message. The deferral assessment system can remain in the “Awards Not Being Offered for Deferrals” state for the events illustrated in FIG. 6. Note that timeouts as described above are required for conflict free operation of the deferral system. The deferral assessment system can be a spatially or geographically distributed system.

### Method for Revenue Management in Communication Network or Services

This method according to the present invention assigns prices and forecasts availability based on supply-and-demand price models for rendering communications services based on imminent communications network usage. When a user requests a communication network or service, for example, a voice, fax or video connection, or a file download via a user device, the access and use management system evaluates the ability of the communications network to provide the user with the service or to connect the user to a service provider either immediately or delayed and at what cost. Based on this evaluation, the user is being offered varying perceived costs for the immediately or the delayed service use. The pricing model for determining the offered costs can provide incentives for delayed service offering or connection.

The access and use management system determines the offers or incentives. The access and use management system can provide the user with a selection of mutually exclusive offers. Alternatively, the user can be presented with a single offer to choose either to accept or to reject. Services which are still pending can be voided by the user by submitting a cancellation request. Cancellation requests can be subject to penalties. The pricing model for communications services can take into account cancellation requests. The pricing model can be of a flat fee or usage based nature. It is obvious to a person skilled in the art that the user can subscribe to or pay per use for a deferred service agreement.

### EXAMPLES

### Access and Use Management System for a Wireless Network

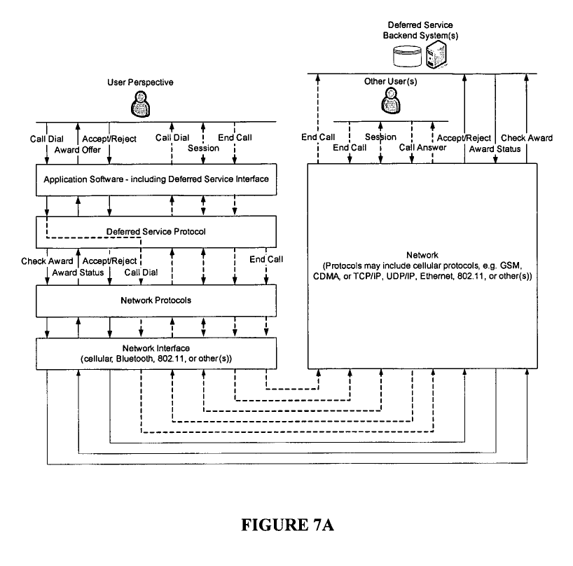

The functionality of an embodiment of the access and use management system is schematically illustrated in FIGS. 7a, 7b, 8a, 8b, 9a and 9b. FIG. 7a illustrates a flow diagram for a state of the system when an award is offered to a user who initiates an outgoing call. The user initiates a call request, for example, the user dials a phone. The deferral management system in the phone transparently tries to request the service querying the deferral assessment system by transmitting a check award message and awaits a response. The deferral management system uses the communication protocol software and physical network interface built into the user device. If the network traffic is beyond a predefined threshold the deferred service assessment system can offer an award. Additionally, the deferral assessment system can monitor network traffic. The deferral assessment system generates an award offer as well as monitors information it acquires about the network traffic.

The award calculation can take user profiles into consideration to assess the typical user behaviour, for example how often a user has accepted or rejected awards. Additionally, the deferral assessment system can apply a more thorough user profile analysis to compute individually optimized awards. It is obvious that the deferral assessment system also updates and maintains the user profile. Updating as well as querying of user profile information can happen at every service request, sporadically, intermittently or periodically according to any desired sampling scheme. The user profile can be stored in a database system and it can contain information such as a user identification code, time, geographical and award information of previous service requests or any other information. A deferral service protocol can be embedded into any other desired network information exchange protocol that facilitates the information exchange between the deferral management system and the deferral assessment system.

The user interface of the user device communicates with the deferral management system and can provide the user with the award offer who can accept or rejects the offer. Subsequent to the user accepting or rejecting the award, the user device via the deferral management system creates and transmits a respective acknowledgement for recording in the user profile and the user's decision with respect to the particular award offer can be recorded. As illustrated in FIG. 7a the dashed lines indicate conditional signal flow.

If the user rejects the award offer the user device tries to connect to the requested service to establish a communication session without further querying the access and use management system. Optionally, the deferral management system can detect a session termination if a previous award offer was rejected to transmit any relevant information about the session for recording in the user profile.

Note that all messaging involving the deferral assessment system has certain real time requirements in order to be useful. For example, the delay between a service request and an award offer must not be delayed arbitrarily. Ideally an award is being offered within the attention span of a user expects during which the user expects delivery of the requested service.

Furthermore, the access and use management system can be implemented in a distributed fashion and consequently communications between elements of the access and use management system can have their own routing amongst the components of the system. For example, the deferred service management system in the user device can communicate with the database system and the deferral assessment system. The communication for updating user profiles may not require stringent real time characteristics.

FIG. 7b illustrates a flow diagram for a state of the system when an award is offered to a user who receives an incoming call. As described for FIG. 7a the one of the other users initiates an outgoing call. The deferral management system on the user device detects the incoming call and queries the deferral assessment system for any award offers to determine if an award is currently being offered. The deferral assessment system monitors the network traffic and it can offer an award as described above, for example, if the network traffic exceeds a defined threshold. Similarly to the above, the deferral management system may connect the user to the incoming service to establish a session. Moreover, the deferral management system can also maintain records of usage history in user profiles for the user who is receiving an incoming call.

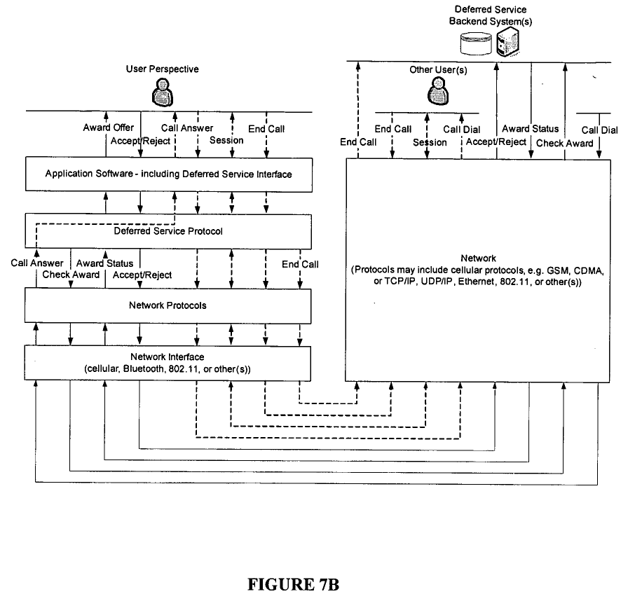

FIG. 8a illustrates a flow diagram for a state of the system when interrupts occur during a pending agreement. An agreement is pending for as long as its previously accepted award offer has not expired and the respective session has not been established during the deferral period. Interrupts can be cause by the user cancelling the service request, the user attempting to request another session or the user receiving an incoming service request. Generally, the deferral management system reminds the user of the pending agreement and the user will have the opportunity to maintain or to opt out of the agreement.

When the user requests a second service, the deferral management system in the user device detects the request and notifies the user that there is a pending agreement for an initial service, for example, it can configure the user device to display “You accepted an award of five free minutes and have a four minute deferred service period remaining. Placing your request will void the award!” or “You accepted an award of 1 free song . . . ” or “You accepted a 50¢ credit . . . ”, for example. If the user selects to maintain the agreement the request for the second service is terminated and no network transmission will be initiated. If the user selects to cancel the initial service, a “Void Award” message can be transmitted to the deferral assessment system which can record the event in the user profile in the database system. Subsequently, the session procedure as described in FIG. 7a takes control. Similarly to the above, a session termination message can be transmitted to the deferred service management system at the end of the session.

FIG. 8b illustrates a flow diagram for a state of the system when an incoming session request is received during a pending agreement. As described under FIG. 8a, when an award has been offered and accepted, and during the agreed deferral period and the deferral management system in the user device receives an incoming session request, the user device will be configured to remind the user of the agreement and the user will have the opportunity to maintain the agreement or opt out. The reminder can be displayed on the user device as described above and the user can be offered to walk through the same question and answer procedure as described above under FIG. 8a.

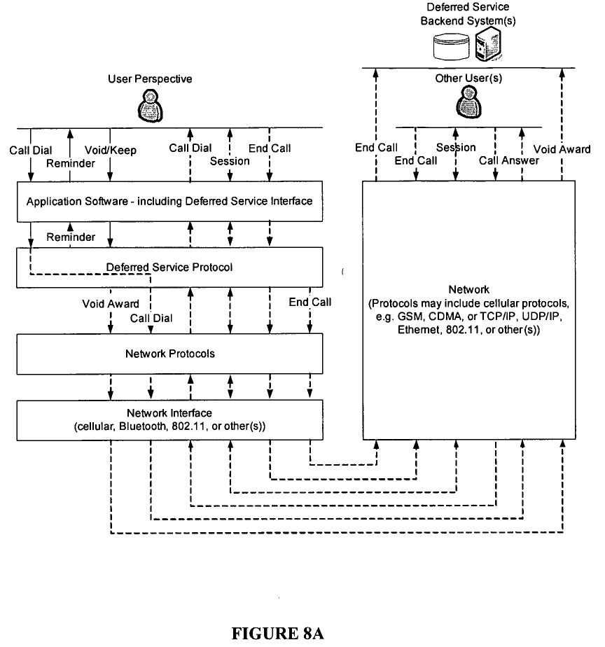

FIG. 9a illustrates a flow diagram for a state of the system when no award is being offered to a user initiating a service request. As described above when the user initiates a service request, the deferral management system verifies that there is no pending award offer and submits a service request to the deferral assessment system. The deferral assessment system may notify the deferral management system that there is no award offer or it may not notify the deferral management system within a predetermined duration, in which case the deferral management system can configure the user device to try to directly connect to the requested service and establish a service session. As described above, the deferral system must process service requests within a certain amount of time. For example, a normal “Call Dial” procedure can be set up and established exactly as it would be without the deferral system.

The deferral assessment system can record the denial of award offer with the service request in the user profile similar to the description above. Additionally, the deferral management system can transmit specific information relevant to session when that session ends for updating the user profile by the deferral assessment system.

FIG. 9b illustrates a flow diagram for a state of the system when no award is being offered to the user receiving a service request. For example, one of the other users initiates a call and the deferral management system in the user device queries the deferral assessment system for an award offer and an award offer is not granted. Subsequently, similarly to what is described above, the user device tries to connect to the requested service without further involving the deferral assessment system. Also similarly, the deferral management system in the user device can submit information for recording in the database system relevant to a session when the session ends. This information can be applied by the deferral assessment system to update the user profile in the database system.

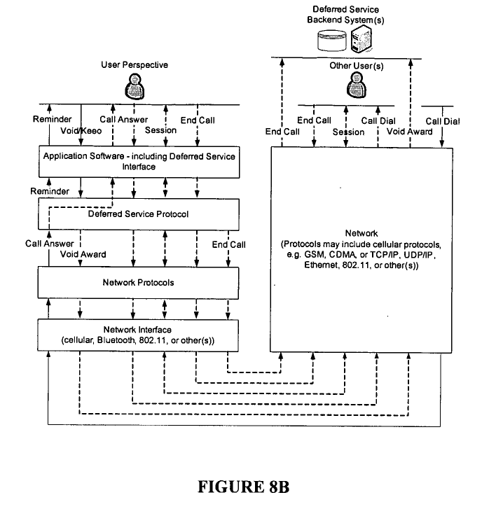

FIG. 10 illustrates a wireless network architecture according to embodiments of the access and use management system. The wireless network architecture comprises user devices which can communicate with link stations which are illustrate as antenna towers. Network traffic is subsequently concentrated in a traffic aggregator where it is transformed to be compatible for submission to a data network service to which database servers and application servers are connected. The composition of the access and use management system is described above.

Note that the above exemplifies the access and use management system for voice services. Other simultaneously available services, for example, fax, email, or other messaging services can also be controlled by the access and use management system or alternatively can be directly established without a access and use management system.

### Modelling of the Access and Use Management System

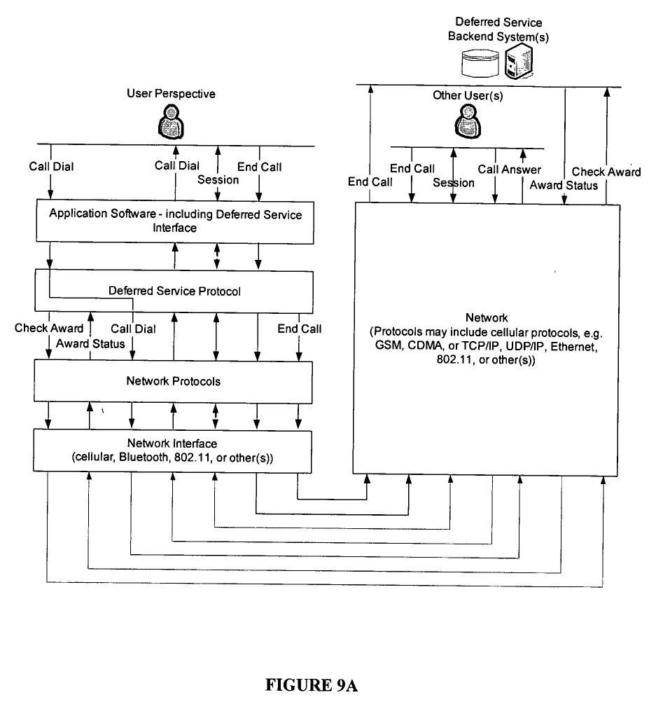

FIG. 11 illustrates the effect of demand resulting from free service in exchange for delayed service. Demand is modeled by functions of arrival rate of connection requests and/or Erlangs—see below.

### User Behaviour

If awards are granted as free use of same service for a deferral time H the users basically flip a coin on the service deferral based on their knowledge of their own call statistics.

$$E [ H ] = \frac{1}{μ}$$

$$c = \frac{r}{μ}$$

$$v ( c ) = v ( r , a )$$

$$\frac{\partial }{\partial r} v ( r , a ) > 0$$

$$\frac{\partial }{\partial a} v ( r , a ) \leq 0$$

$${lim}_{a \to 1} v ( r , a ) \to 0$$

$$A = \{ \begin{matrix}1 , & \frac{1}{μ} \leq v ( r , a ) \\ 0 , & otherwise\end{matrix} \\ r ( a ) = {arg min}_{r} \{ \frac{1}{μ} \leq v ( r , a ) \} = \{ r : \frac{1}{μ} = v ( r , a ) \}$$

The award model conservatively assumes that service will lose all value by deferral but that the user will still consume the service. Since there is likely to be some residual value of the service the deferral estimate is conservative which is appropriate for an optimization model planning on the users' consent to defer use. The above formulas can provide good estimates on performance limits, in order to manage a system where acceptance is estimated online based on what users will actually take.

Note that 0≦a≦1 as it is not possible to defer more than every user at any state. Offering users free service in exchange for delayed service can create more demand as graphically illustrated in FIG. 11.

The deferrals can be restricted to a subset of states greater than n and a level of utilization below which r=0 and thus a=0. Consequently, the system operator does not request users to defer service through the award offer r.

Relative to the presumed arrival rate λ, the proportional rate of deferrals, d, the shifted demand to all periods from previously loaded periods, s, and the overall growth in utilization, g, can be given by the series,

$$d = \frac{a}{1 - ar}$$

$$s = \frac{a}{1 - ar} {\sum }_{k = n}^{c} {π}_{k} = d {\sum }_{k = n}^{c} {π}_{k}$$

$$g = \frac{ar}{( 1 - ar )} {\sum }_{k = n}^{c} {π}_{k} ( n , a ) = dr {\sum }_{k = n}^{c} {π}_{k} ( n , a )$$

$$d - s - g \leq 1 \to {\sum }_{k = n}^{c} {π}_{k} ( n , a ) \leq 1 - \frac{1}{a ( 1 + r ( a ) )}$$

The above restriction is a consequence on the domain of (n,a) because any (n,a) that does not result in the system being utilized at a minimum level is not technically feasible, since it can result in negative load on the network in the states greater than n. The probability of the system being on decreases in a (see the queuing analysis below), so that the restriction effectively limits the domain of a to a maximum value of a, given n. Note that it is desirable for d−s−g>0, however, there is no mathematical restriction that requires a choice of (n,a) so that the undesirable case of hurting performance is impossible.

Note that furthermore ar<1 and that if r=−ln(1−a), the above condition requires that a<0.7407.

### Queuing Analysis

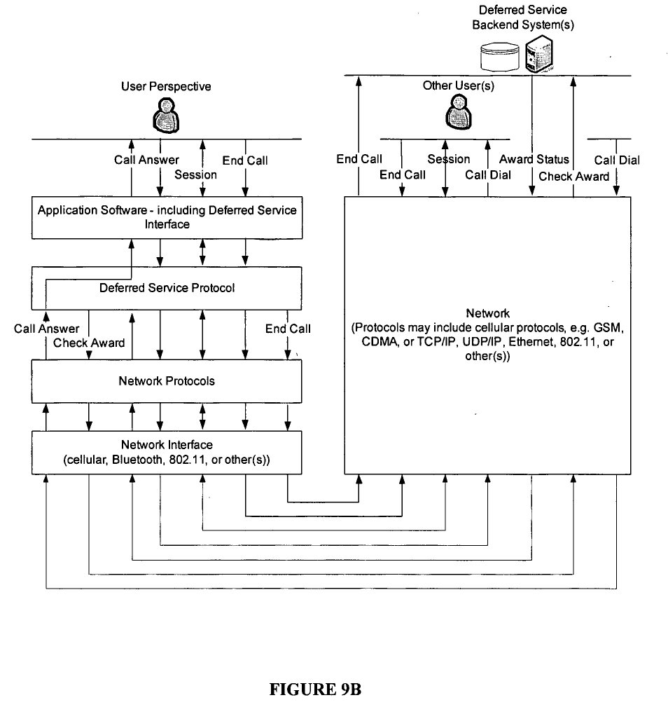

In order to understand the effect of the deferred service scheme, consider the overall queuing system as illustrated in FIG. 12. The flow balance equations between any two nodes require that in equilibrium,

λ(1+s+g)πₖ₋₁=kμπₖ, 1≦k≦n

λ(1−d+s+g)πₖ₋₁=kμπₖ, n+1≦k≦c

λ(1−d+s+g)πₖ₋₁=cμρₖ, k≧c+1

An ergodic Markov chain, such as the well known birth-death process as described above, can have an equilibrium solution which can be written in the form,

$${π}_{k} = {π}_{0} {\prod }_{i = 0}^{k - 1} \frac{{λ}_{i}}{{μ}_{i + 1}} , k \geq 1$$

$${π}_{0} = \frac{1}{1 + {\sum }_{k = 1}^{∞} {\prod }_{i = 0}^{k - 1} \frac{{λ}_{i}}{{μ}_{i + 1}}}$$

The convenient notation λᵢ, μᵢ to represents the birth and death rates out of the various states of the queue, rather than writing separate equations for terms such as λ(1−d+s+g), kμ, etc.

The underlying queuing system in can be considered in two ways. For example, an M/G/m queue in which users wait for service, for example, they continuously redial a phone until the call is connected, and an M/G/m/m queue, if blocked requests are lost by the system. The illustrated queuing system can take on these forms, if we set a=r=0.

To solve the steady-state probabilities for the M/G/m queue, the queue can be analyzed in two parts which are labelled “available” and “busy”. The analysis yields the distribution of the steady state probabilities of the queue, and in particular the Erlang C formula for queuing in the busy state of the system. The relationships for the M/G/m queue can be given by,

$${π}_{k} = \{ \begin{matrix}{π}_{0} \frac{{( m ρ )}^{k}}{k !} , & k \leq m \\ {π}_{0} \frac{{m}^{m} {ρ}^{k}}{m !} , & k \geq m\end{matrix} \\ {π}_{0} = {[ {\sum }_{k = 0}^{m - 1} \frac{{( m ρ )}^{k}}{k !} + \frac{{m}^{m} {ρ}^{m}}{m !} ( \frac{1}{1 - ρ} ) ]}^{- 1} \\ ρ = \frac{λ}{m μ}$$

The Erlang C formula is,

$${π}_{busy} = \frac{\frac{{( m ρ )}^{m}}{m !} ( \frac{1}{1 - ρ} )}{{\sum }_{k = 0}^{m - 1} \frac{{( m ρ )}^{k}}{k !} + \frac{{( m ρ )}^{m}}{m !} ( \frac{1}{1 - ρ} )}$$

Similarly, the distribution for the M/G/m/m queue and the Erlang B formula for blocking are,

$${π}_{k} = \{ \begin{matrix}{{π}_{0} ( \frac{λ}{μ} )}^{k} \frac{1}{k !} , & k \leq m \\ 0 , & k > m\end{matrix} \\ {π}_{0} = {[ {\sum }_{k = 0}^{m} {( \frac{λ}{μ} )}^{k} \frac{1}{k !} ]}^{- 1}$$

The Erlang B formula is,

$${π}_{busy} = \frac{\frac{{( λ / μ )}^{m}}{m !}}{{\sum }_{k = 0}^{m} \frac{{( λ / μ )}^{k}}{k !}}$$

If a>0, an analysis similar to that which can yield the above equations previously labeled regular service, deferred service and busy.

For an underlying M/G/m queue, the distribution and probability of being found in the busy state for the deferred service model can be described by,

$${π}_{k} = \{ \begin{matrix}{π}_{0} \frac{{( m ρ ( 1 + s + g ) )}^{k}}{k !} , & k \leq n \\ {π}_{0} \frac{\begin{matrix}{( m ρ )}^{k} {( 1 + s + g )}^{n} \\ {( 1 - d + s + g )}^{k - n}\end{matrix}}{k !} , & n + 1 \leq k \leq m , n < m \\ {π}_{0} \frac{\begin{matrix}{m}^{m} {{ρ}^{k} ( 1 + s + g )}^{n} \\ {( 1 - d + s + g )}^{k - n}\end{matrix}}{m !} , & k \geq m\end{matrix} \\ {π}_{0} = {[ \begin{matrix}{\sum }_{k = 0}^{n} \frac{{( m ρ ( 1 + s + g ) )}^{k}}{k !} + {\sum }_{k = n + 1 \\ n < m}^{m - 1} \frac{\begin{matrix}{( m ρ )}^{k} {( 1 + s + g )}^{n} \\ {( 1 - d + s + g )}^{k - n}\end{matrix}}{k !} + \\ \frac{\begin{matrix}{m}^{m} {{ρ}^{m} ( 1 + s + g )}^{k} \\ {( 1 - d + s + g )}^{m - n}\end{matrix}}{m !} ( \frac{1}{1 - ρ ( 1 - d + s + g )} )\end{matrix} ]}^{- 1} \\ ρ = \frac{λ}{m μ}$$

The probability of finding the system in a busy state, rather than the Erlang C formula, can be expressed as

$${π}_{busy} = \frac{\begin{matrix}\frac{{m}^{m} {{ρ}^{m} ( 1 + s + g )}^{n} {( 1 - d + s + g )}^{m - n}}{m !} \\ ( \frac{1}{1 - ρ ( 1 - d + s + g )} )\end{matrix}}{[ \begin{matrix}{\sum }_{k = 0}^{n} \frac{{( m ρ ( 1 + s + g ) )}^{k}}{k !} + \\ {\sum }_{k = n + 1}^{m - 1} \frac{{( m ρ )}^{k} {( 1 + s + g )}^{n} {( 1 - d + s + g )}^{k - n}}{k !} + \\ \begin{matrix}\frac{{m}^{m} {{ρ}^{m} ( 1 + s + g )}^{n} {( 1 - d + s + g )}^{m - n}}{m !} \\ ( \frac{1}{1 - ρ ( 1 - d + s + g )} )\end{matrix}\end{matrix} ]}$$

Similarly, for an underlying M/G/m/m queue, the distribution and probability of being found in the busy state for the deferred service model are now described by,

$$\begin{matrix}{π}_{k} = \{ \begin{matrix}{{π}_{0} ( \frac{λ ( 1 + s + g )}{μ} )}^{k} \frac{1}{k !} , & k \leq n \\ {{π}_{0} ( \frac{λ}{μ} )}^{k} \frac{1}{k !} {( 1 + s + g )}^{n} {( 1 - d + s + g )}^{k - n} , & n + 1 \leq k \leq m \\ 0 , & k > m\end{matrix} \\ {π}_{0} = {[ \begin{matrix}{\sum }_{k = 0}^{n} {( \frac{λ ( 1 + s + g )}{μ} )}^{k} \frac{1}{k !} + \\ {\sum }_{k = n + 1}^{m} {( \frac{λ}{μ} )}^{k} \frac{1}{k !} {( 1 + s + g )}^{n} \\ {( 1 - d + s + g )}^{k - n}\end{matrix} ]}^{- 1}\end{matrix}$$

The probability of finding the system in a busy state, rather than the Erlang B formula can be expressed as

$${π}_{busy} = \frac{{( \frac{λ}{μ} )}^{m} \frac{1}{m !} {( 1 + s + g )}^{n} {( 1 - d + s + g )}^{m - n}}{\begin{matrix}{\sum }_{k = 0}^{n} {( \frac{λ ( 1 + s + g )}{μ} )}^{k} \frac{1}{k !} + \\ {\sum }_{k = n + 1}^{m} {( \frac{λ}{μ} )}^{k} \frac{1}{k !} {( 1 + s + g )}^{n} \\ {( 1 - d + s + g )}^{k - n}\end{matrix}}$$

Note that for any (n,a) there can be a unique distribution p. Note further that for any stable underlying queue (M/G/m or M/G/m/m), there can be n,a>0, d(n,a)−s(n,a)−g(n,a)>0 such that the busy probability in the corresponding deferred service model queue is less than the busy probability in the underlying queue.

To be economical and not increase utilization during peak network traffic times by the deferring service, restrictions on the acceptance rate are required for stability of the queue.

Note that a technical requirement for an underlying M/G/m/m queue is that n<m. In other words, for any stable underlying queue, there exists a non-empty domain (n,a) for the function π_{busy}(n,a)<π_{busy}(a=0) which follows from

$$\begin{matrix}{β}_{k} \{ \begin{matrix}{( 1 + s + g )}^{k} , & k \leq n \\ {( 1 + s + g )}^{n} {( 1 - d + s + g )}^{k - n} , & k \geq n + 1\end{matrix} \\ {π}_{k} = {π}_{0} \frac{{π}_{k}^{M}}{{π}_{0}^{M}} {β}_{k} , k \geq 0 \\ {π}_{0} = \frac{1}{1 + {\sum }_{k > 0} \frac{{π}_{k}^{M}}{{π}_{0}^{M}} {β}_{k}} \\ {π}_{busy} = \{ \begin{matrix}{π}_{m} ( \frac{1}{1 - ρ ( 1 - d + s + g )} ) , & M \text{/} M \text{/} m \\ {π}_{m} , & M \text{/} M \text{/} m \text{/} m\end{matrix} \\ {π}_{busy} = \{ \begin{matrix}{π}_{0} \frac{{π}_{m}^{M}}{{π}_{0}^{M}} {β}_{m} ( \frac{1}{1 - ρ ( 1 - d + s + g )} ) , & M \text{/} M \text{/} m \\ {π}_{0} \frac{{π}_{m}^{M}}{{π}_{0}^{M}} {β}_{m} , & M \text{/} M \text{/} m \text{/} m\end{matrix}\end{matrix}$$

Note the technical requirement in the equations that n<m for the second set of recursive equations, and in the second term in π₀. If n is chosen equal to m, the second set of recursive equations and the summation that makes up the second term of the π₀ expression disappear.

Similarly, For an underlying M/G/m/m queue, the distribution and probability of being found in the busy state for the deferred service model are now described by,

This depends on the behavior of the solution with respect to,

$$d - s - g > 0 -> {\sum }_{k = n}^{c} {π}_{k} < \frac{1}{1 + r}$$

The above expression is decreasing in a, and the probability of being in an on state is between zero and 1. Note that limit a=0 yields the original stable queue for any n.

Provided there is some small value of a, s.t. πₒₙ(m,a)<1/(1+r(a)) in the case of an M/G/m queue or πₒₙ(m−1,a)<1/(1+r(a)), in the case of M/G/m/m queue and a<0.7407 assumed), then the transition rate into the busy state is reduced.

Note for any πₒₙ>(1/1+r) with a>0, all states have higher transition rates in and therefore performance would be worse.

If the system is oversubscribed (unsatisfactory availability) there can be a unique solution to max availability choosing (n,a). This depends on the derivative of π_{busy}.

Note that for a fixed price, the revenue maximizing subscription to the service can be oversubscribed, with the maximum availability policy (n,a), such that π_{busy} (n,a,population)=busy tolerance. The following award function can be chosen

$$\begin{matrix}v ( r , a ) = \frac{r ( 1 - α a )}{μ} \\ r ( a ) = \frac{1}{1 - α a} , 0 \leq a \leq \frac{1}{α}\end{matrix}$$

If β<1 users on average receive value in instant minutes more than award minutes plus deferred minutes. For β>1 the average award minutes can compensate users for the value lost by not being able to connect a call instantly.

The award expression conservatively assumes that service will lose all value by deferral but the user still returns and consumes the service. Since there is likely to be some residual value of the service the deferral estimate is conservative—appropriate for an optimization model planning on users' acceptance of deferred use. These formulations will provide a bound on performance, in order to manage a system where acceptance is estimated online based on what users will actually take.

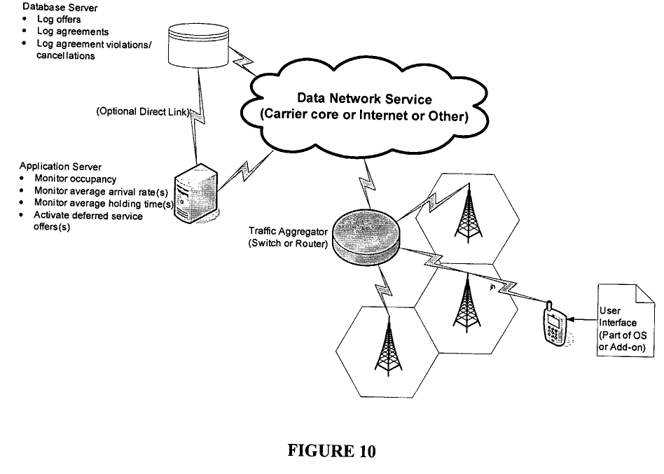

FIG. 13 illustrates simulated antenna availability in a deferred service setting in accordance with an embodiment of the present invention.

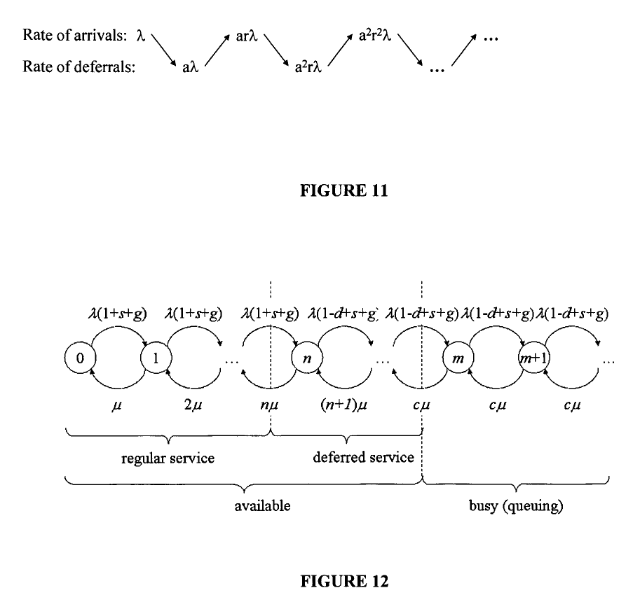

FIG. 14 illustrates simulated antenna availability in a deferred service setting in accordance with an embodiment of the present invention.

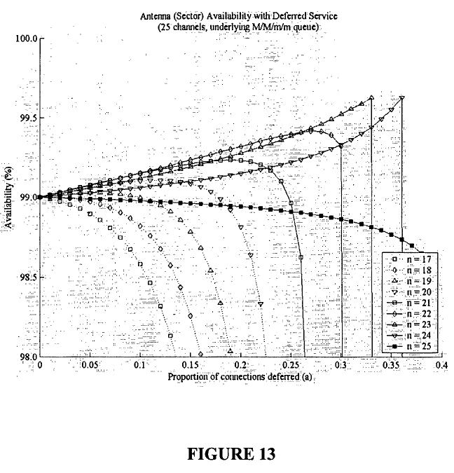

FIG. 15 illustrates optimal service in accordance with an embodiment of the present invention.

Delay is proportional to the average hold time of a call in the network for example may be selected from the range of 3 to 5 times the average hold time.

### Alternate Model of the Access and Use Management System

Note: Definitions of variables in the text below, such as a, r, g, πₒₙ, etc. may differ slightly from the previous embodiment.

In real-time communications services, such as wireless voice, service quality deteriorates as loads become heavy. For example, consider mobile telephony. As demand (traffic intensity) approaches the service capacity (antenna capacity), service availability deteriorates rapidly. Other service deterioration includes voice quality and dropped calls. Finally when the system reaches capacity, access is completely unavailable. Therefore, it is desirable to manage users such that system performance remains satisfactory and it is typically sufficient to design capacity to achieve a performance target on limiting the amount of time the system is busy, for example the access network may be designed to limit the busy probability to 1%.

If an offer of additional free service to users who intermittently agree to defer single requests for service is added to the normal method of accessing the network, capacity can be effectively increased, enabling increases in service quality, decreases in busy periods, increased system throughput or some combination of all or some of the benefits. Cooperative users may pay a significantly lower average price for service since users will have many opportunities to trade convenience for more service. In fact, each user could receive a unique availability and pay a unique average price. Real-time services have no reservations and therefore instances of excess demand cannot be prevented but must be managed as they occur. Current practices do not include management of excess demand in real-time communication network or services.

### User Behaviour Model

The individual user values ν of immediate connections (i.e. not including delay preferences) are i.i.d. draws from a distribution Φ.

V˜Φ(ν)

Users consume multiple times. The utility u derived from a connection is simply u=ν−p, where p is the price. Given a maximum market size Λ, and a price p₀, demand or arrivals to the system, λ, have a value greater than or equal to the price, which can give a demand relationship, λ(p₀)=Λ(1−Φ(p₀)). The inverse demand function is,

$$p ( {λ}_{0} ) = {Φ}^{- 1} ( 1 - \frac{{λ}_{0}}{Λ} )$$

Arrival Process with Deferred Service

The deferred service model introduces an additional step in the arrival process. At the time of any individual arrival, the user may be asked by the system to defer service until a later time. In return, the system will grant the user additional free use of r/μ free minutes of use per deferral (i.e. the award rate r determined in the model is related to the expected duration of a connection, 1/μ) (formally, μ is the average service rate). Note that a request that is deferred has a service time of zero.

With probability πₒₙ an arriving user may find the system in an “on” state and be presented with an offered award r. With probability a, r is sufficiently attractive for the user to accept deferral. Users' total consumption will still be defined by the demand curve above, but now the effective price is lower (more service has been acquired).

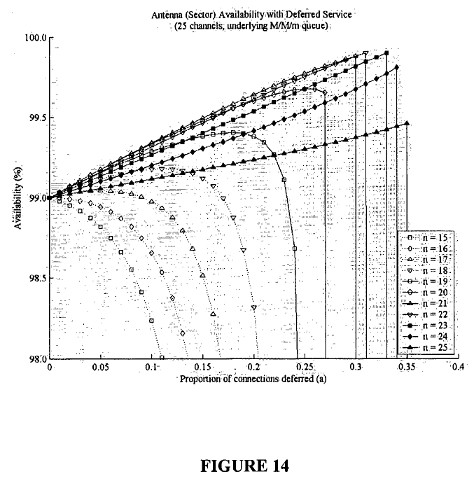

Requests for service are spread out over both states, “off” and “on” Therefore, the average arrival rate of requests will increase, by πₒₙar, the amount of free requests given in return for deferrals with probability πₒₙ a request is offered deferred service and a that the offer will result in acceptance. Therefore, by giving users additional free service, the arrival rate of requests is increased in all periods. Of course the new demand is subject to the same logic just outlined. The resulting effect on demand for service is illustrated in FIG. 16.

The sequence in FIG. 16 represents the effects on arrival rate of requests and throughput. At the left edge of node 1, the user decides to request connections. Proceeding to node 2, the user may or may not be offered a award for deferral (with probabilities πₒₙ and (1−πₒₙ) respectively). If the deferred service is “on” node 3 represents the thinning of requests entering the system. With probability a users accept deferral and with probability (1−a) users enter the system. Throughput for deferred requests is zero. For the other two possible outcomes, declining the award offer or not being offered a award, throughput is initially λ₀, the same rate as the initial demand. These three possibilities are denoted in the first row of each “page” in the column labeled “Throughput Rates by State”. The deferred service (the top set of calculations) on the “pages” under “Throughput Rates by State” feeds back into the arrival rate of requests. The rate of requests created by deferring service is πₒₙaλ₀ in the first row of the “pages” in the “Deferred Requests” column. The effect of this marginally decreasing volume of additional requests is calculated in total on the “pages” labeled “1” in each column. Finally, all the demand that is deferred in the first iteration of this logic, πₒₙaλ₀/(1−πₒₙa) is awarded at a rate of r requests per deferred requests and feeds back from the final column of the decision tree, “Award Rates” to the initial demand in the first column. This new demand is row 2 and is subject to the same decision logic as the initial λ₀.

Summarizing the logic above average throughput of the system is λ̅, based on the original arrival rate to the system λ₀, and the deferred service quantities, πₒₙ, a and r, λ̅=gλ₀≧λ₀ where,

$$\begin{matrix}g = \frac{1}{1 - \frac{{π}_{on} ar}{1 - {π}_{on} a}} \\ 0 \leq {π}_{on} , a \leq 1 \\ 0 \leq r < \frac{1 - {π}_{on} a}{{π}_{on} a}\end{matrix}$$

The service provider's choice of r is limited so that the geometric series above converges.

### Deferred Service Choice

If consumption is not immediate there can be a delay cost to the user as expressed by u=νc−k−p, c and k represent degradation in service value due to deferral. There is a discount factor c and a fixed cost of delay k. Subtracting u from price v from the value of the immediately served connection, the cost of deferral can be expressed as Δ=(1−c)ν+k.

The delay in accessing the service for the deferred request must be greater than some minimum value T, set by the service provider. The length of time any individual request is deferred is random, but is assumed to be sufficiently long to restore the steady state distribution of the queue occupancy upon the individual users return. For example, the service rate in wireless services is about halve a requests per minute, i.e. the average holding time is about 2 minutes, so that a deferral of only 5-10 minutes is likely to be sufficient.

A user will accept a deferral offer made by the system at the time of arrival if disutility (cost of deferral) is less than r equal to the expected value of additional free consumption,

(1−c)ν+k≦rE[V|ν>p(gλ₀)]

Users decide accept a deferral based on the value of an individual connection just requested. (1−c)ν+k represents the disutility of deferring the connection. The expected value of the free service provided as a award for deferral is the product of the award rate r and the expected value of individual connections E[V|ν>p(gλ₀)], which incorporates information about the decreasing marginal value of requests after the distribution of free minutes through g. Recall that r is denominated in units of free (expected) connections based on average holding time 1/μ.

The proportion a of accepted deferral offers for a given value r (i.e. one value of r for all users not an auction) is given by,

$$a = P [ v < \frac{rE [ V \vert v > p ( g {λ}_{0} ) ] - k}{1 - c} \vert v \geq p ( g {λ}_{0} ) ]$$

Alternatively,

$$\begin{matrix}a = \frac{Φ ( {v}^{*} ) - Φ ( p ( g {λ}_{0} ) )}{1 - Φ ( p ( g {λ}_{0} ) )} \\ where \\ {v}^{*} = \frac{rE ⌊ V \vert ( g , {p}_{0} ) ⌋ - k}{( 1 - c )} \geq p ( g {λ}_{0} )\end{matrix}$$

The above can be further simplified using the demand relationships,

$$a = ( 1 - \frac{λ ( {v}^{*} )}{g {λ}_{0}} )$$

Note that if

$$r \leq min \{ \frac{1 - {π}_{on} a}{2 {π}_{on} a} , \frac{{( 1 - {π}_{on} a )}^{2}}{{π}_{on} - {( {π}_{on} a )}^{2}} \} ,$$

the award required for acceptance can increase in a.

The condition is not restrictive. For example, consider using the deferred service offers infrequently with half of users participating, e.g. πₒₙ=10% and a=50%. The condition would require r≦9.26. On the other hand if the deferred service offers were heavily used, e.g. πₒₙ=30% and a=80%, the condition then requires r≦1.58. Clearly, the bound on maximum award becomes relevant as πₒₙ and a increase, ultimately defining the boundary on the domain of values for which deferred service is viable. However, the domain of operation appears to be quite large.

Note that the award rate required for participation (a>0) is bounded from below by,

$$r ( a ) > \frac{( 1 - c ) {p}_{0} + k}{E [ V \vert {p}_{0} ]}$$

### Analysis of the Deferred Service Queue

The central feature of the queuing analysis is the distinction between two aggregated states, “off” and “on”. In the “on” state the arrival rate is reduced by a proportion a. This proportion of requests accepts deferred service and returns for service after a period of time. The probability of the “on” state is πₒₙ. Returning traffic is apparent in both “off” and “on” states.

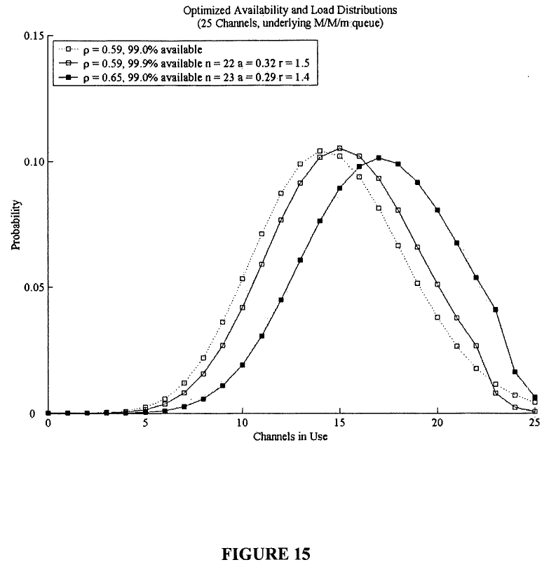

The service provider chooses a state n and an award r. For all states of n occupants or greater, an award r is offered for a deferred service agreement with the user. The goal is to reduce the likelihood of the system being busy (state m or higher) when requests arrive. Consider the queuing system model illustrated in FIG. 17, which shows the reduction of processed requests in the “on” states. The instantaneous arrival rates to the queue are taken from the decision tree in FIG. 16.

The definition of πₒₙ is,

$${π}_{on} = {\sum }_{i \geq n} {π}_{i} ( a , r , {π}_{on} )$$

πᵢ, represents the probability of the queue being occupied by i users. Note that πₒₙ is an implicit function.

### Flow Balance Equations

The flow balance equations across any cut between nodes requires that in equilibrium,

$$\begin{matrix}\frac{1}{1 - {π}_{on} a} g {λ}_{0} {π}_{i - 1} = i {μπ}_{i} , 1 \leq i \leq n \\ \frac{1 - a}{1 - {π}_{on} a} g {λ}_{0} {π}_{i - 1} = min ( i , m ) {μπ}_{i}\end{matrix}$$

The form of the solution (assuming it exists) for an ergodic Markov chain, such as our birth-death process above is well-known,

$$\begin{matrix}{π}_{i} = {π}_{0} {\prod }_{j = 0}^{i - 1} \frac{{λ}_{j}}{{μ}_{j + 1}} , i \geq 1 \\ {π}_{0} = \frac{1}{1 + {\sum }_{i = 1}^{∞} {\prod }_{j = 0}^{i - 1} \frac{{λ}_{j}}{{μ}_{j + 1}}}\end{matrix}$$

### Queuing Distribution Solution

The distribution for the deferred service model in this case is,

$$\begin{matrix}{π}_{k} = \{ \begin{matrix}{π}_{0} \frac{1}{i !} {( \frac{g {λ}_{0}}{( 1 - {π}_{on} a ) μ} )}^{i} , & 1 \leq i \leq n \\ {π}_{0} \frac{1}{i !} {( \frac{g {λ}_{0}}{( 1 - {π}_{on} a ) μ} )}^{i} {( 1 - a )}^{i - n} , & n \leq i < m \\ {π}_{0} \frac{1}{{m}^{i - m} m !} {( \frac{g {λ}_{0}}{( 1 - {π}_{on} a ) μ} )}^{i} {( 1 - a )}^{i - n} , & i \geq m\end{matrix} \\ {π}_{0} = {[ \begin{matrix}1 + {\sum }_{i = 1}^{n - 1} \frac{1}{k !} {( \frac{g {λ}_{0}}{( 1 - {π}_{on} a ) μ} )}^{i} + {\sum }_{i = n}^{m - 1} {π}_{0} \frac{1}{i !} {( \frac{g {λ}_{0}}{( 1 - {π}_{on} a ) μ} )}^{i} {( 1 - a )}^{i - n} + \\ \frac{1}{m !} {( \frac{g {λ}_{0}}{( 1 - {π}_{on} a ) μ} )}^{m} {( 1 - a )}^{m - n} ( \frac{1}{1 - ( \frac{1 - a}{1 - {π}_{on} a} ) \frac{g {λ}_{0}}{m μ}} )\end{matrix} ]}^{- 1}\end{matrix}$$

The probability of finding the system in a busy state is,

$${π}_{busy} = \frac{\frac{1}{m !} {( \frac{g {λ}_{0}}{( 1 - {π}_{on} a ) μ} )}^{m} {( 1 - a )}^{m - n} ( \frac{1}{1 - ( \frac{1 - a}{1 - {π}_{on} a} ) \frac{g {λ}_{0}}{m μ}} )}{[ \begin{matrix}1 + {\sum }_{i = 1}^{n - 1} \frac{1}{k !} {( \frac{g {λ}_{0}}{1 - {π}_{on} a} )}^{i} + {\sum }_{i = n}^{m - 1} {π}_{0} \frac{1}{i !} {( \frac{g {λ}_{0}}{( 1 - {π}_{on} a ) μ} )}^{i} {( 1 - a )}^{i - n} + \\ \frac{1}{m !} {( \frac{g {λ}_{0}}{( 1 - {π}_{on} a ) μ} )}^{m} {( 1 - a )}^{m - n} ( \frac{1}{1 - ( \frac{1 - a}{1 - {π}_{on} a} ) \frac{g {λ}_{0}}{m μ}} )\end{matrix} ] }$$

The stability condition for the queue is,

$$( \frac{1 - a}{1 - {π}_{on} a} ) g {λ}_{0} < m μ$$

### Distribution Properties

A deferred service queue distribution can be rewritten as,

$$\begin{matrix}{π}_{i} = \frac{{π}_{0} {π}_{i}^{M}}{{π}_{0}^{M}} {α}_{i} , i > 0 \\ {π}_{0} = \frac{1}{1 + {\sum }_{i > 0} \frac{{π}_{i}^{M}}{{π}_{0}^{M}} {α}_{i}} \\ where , \\ {α}_{i} = \{ \begin{matrix}{( \frac{g}{1 - {π}_{on} a} )}^{i} , & i \leq n \\ {( \frac{g}{1 - {π}_{on} a} )}^{i} {( 1 - a )}^{i - n} , & i > n\end{matrix}\end{matrix}$$

The distribution of the M/G/m queue for the given values of λ₀, μ and m is denoted by π^{M}.

Ignoring the user equilibrium, the probability of observing the queue occupancy greater than or equal to n, i.e. the “on” states, increases in both a and r,

$$\frac{\partial }{\partial x} {π}_{on} ( a , r ) > 0 , x ∈ \{ a , r \}$$

The intuition of the above property is simply that both a and r increase the average throughput of the queue through g. The increase is relatively larger in the “off” states compared to the “on” states. Both facts drive the queue to a higher probability of being in the “on” states through any increase in either a or r.

### Decreasing Award Condition

Ignoring the user equilibrium, the steady state distribution of the queue implies a decreasing relationship between a and r, when πₒₙ is fixed.

### Uniqueness of the Deferred Service Distribution

Assuming the user behavior model there is a one-to-one mapping from any value of πₒₙ to a pair (a,r) and a queue distribution (if such a point and such a distribution exist).

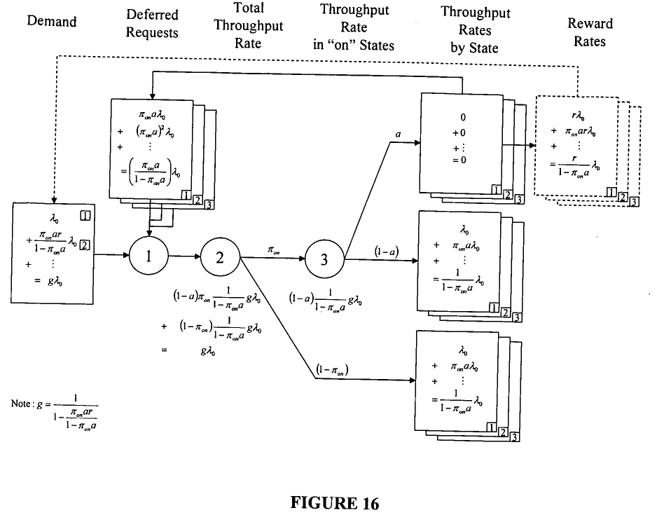

This solution is illustrated in FIG. 18. The user equilibrium a(r) and the queue distribution require that any triple (a, r, πₒₙ) implies a single distribution.

The deferred service scheme can be thought of as a secondary real-time market for access capacity, which was purchased by users in a primary futures market for access capacity. The users may now return some capacity to the carrier for a payment in kind of r additional future minutes of use per minute returned in real-time. In the secondary market for access capacity, the users are perfectly competitive suppliers and the service provider is a monopsonist customer.

### Generalized Uniqueness of Deferred Service Distribution

Assuming the user behavior model there is a one to one mapping from any value of either a, r or πₒₙ to a pair of the remaining two variables and a queue distribution (if such a point and such a distribution exist).

The implication is that setting a policy on either a, r or πₒₙ determines a unique queue distribution. See FIG. 18 for an illustration of the overall equilibrium.

### Numerical Solution Method:

A practical interpretation for the above properties allows calculation of the suitable management policy (a, r, πₒₙ) for any target level of service.

Step 1: Calculate the M/G/m distribution for λ, μ and m. Set a value of πₒₙ,

$${π}_{on} ∈ ( {\sum }_{1 \geq n} {π}_{i}^{M} , 1 )$$

Step 2: Initialize a search interval on a,

(a₁,a₂ )=(0,1)

Step 3: Bisect the search interval, i.e.

$${a}^{′} = \frac{{a}_{1} + {a}_{2}}{2}$$

Step 4: Calculate r′ that satisfies the user equilibrium

$${r}^{′} = r : {a}^{′} = ( 1 - \frac{λ ( {v}^{*} ( {a}^{′} , r , {π}_{on} ) )}{g ( {a}^{′} , r , {π}_{on} ) {λ}_{0}} )$$

Note: This is a numerical search for r′ within the outer loop from Step 3 to Step 5. The inner search loop is not shown. Any search that finds r outside the restricted range is terminated. The algorithm updates the search interval (a₁,a₂):=(a₁,a′) and returns to Step 3.

Step 5: Calculate a″ from r′ and πₒₙ, so that the deferred service distribution is satisfied according to the queue distribution.

$$\begin{matrix}{a}^{″} = a : \{ {\sum }_{k \geq 0} {π}_{i}^{′} ( a , {r}^{′} , {π}_{on} ) = 1 , {\sum }_{i \geq n} {π}_{i}^{′} ( a , {r}^{′} , {π}_{on} ) = {π}_{on} \} \\ where , \\ {π}_{i}^{′} = {π}_{0} \frac{{π}_{i}^{M}}{{π}_{0}^{M}} {α}_{i}^{′} ( a , {r}^{′} , {π}_{on} ) , i > 0 \\ {π}_{0}^{′} = \frac{1}{1 + {\sum }_{i > 0} \frac{{π}_{k}^{M}}{{π}_{0}^{M}} {α}_{i}^{′} ( a , {r}^{′} , {π}_{on} )} \\ {α}_{i}^{′} = \{ \begin{matrix}{( \frac{g ( a , {r}^{′} , {π}_{on} )}{1 - {π}_{on} a} )}^{i} , & i \leq n \\ {( \frac{g ( a , {r}^{′} , {π}_{on} )}{1 - {π}_{on} a} )}^{i} {( 1 - a )}^{i - n} , & i > n\end{matrix}\end{matrix}$$

Note: This is a numerical search for a″ within the outer loop from Step 3 to Step 6. The inner search loop is not shown.

Step 6: Update the search interval according to the following rule,

$$( {a}_{1} , {a}_{2} ) := \{ \begin{matrix}( {a}^{′} , {a}_{2} ) , & {a}^{″} > {a}^{′} \\ ( {a}_{1} , {a}^{′} ) , & {a}^{″} < {a}^{′}\end{matrix}$$

Return to Step 3.

Termination: When a″≈a′, the search terminates.

### Numerical Example: Application to Mobile Telephony

The exponential distribution is used throughout the numerical example, for example Φ(ν)=1−e^{-βν}, where β is the parameter in the distribution. The demand and inverse demand curves for our example are,

$$\begin{matrix}λ ( p ) = {Λe}^{- β p} \\ p ( λ ) = \frac{ln ( Λ ) - ln ( λ )}{β}\end{matrix}$$

Due to the memory-less property the conditional expectation of user value is,

$$E [ V \vert p ] = p + \frac{1}{β}$$

Given an initial demand point (λ₀, p₀), and a total market size as a multiple x of the initial market, i.e. Λ=xλ₀ and x>1, the parameter β in the value distribution is,

$$β = \frac{ln ( x )}{{p}_{0}}$$

Assume the initial price p₀ is 10¢ and the demand for service would double if the price were zero, i.e. Λ=2 λ₀. As a result β=6.93 (with p₀ expressed in dollar units) and the average value of connections is approximately 25¢. The average holding time of a wireless voice call is roughly two minutes, so we use μ=0.5. Finally, we use c=0.1 and k=5¢, i.e. 90% of the expected value of a connection is lost and a fixed cost of 5¢ is incurred by a user when he or she defers.

### Effects of Deferred Service on a 25 Channel Antenna

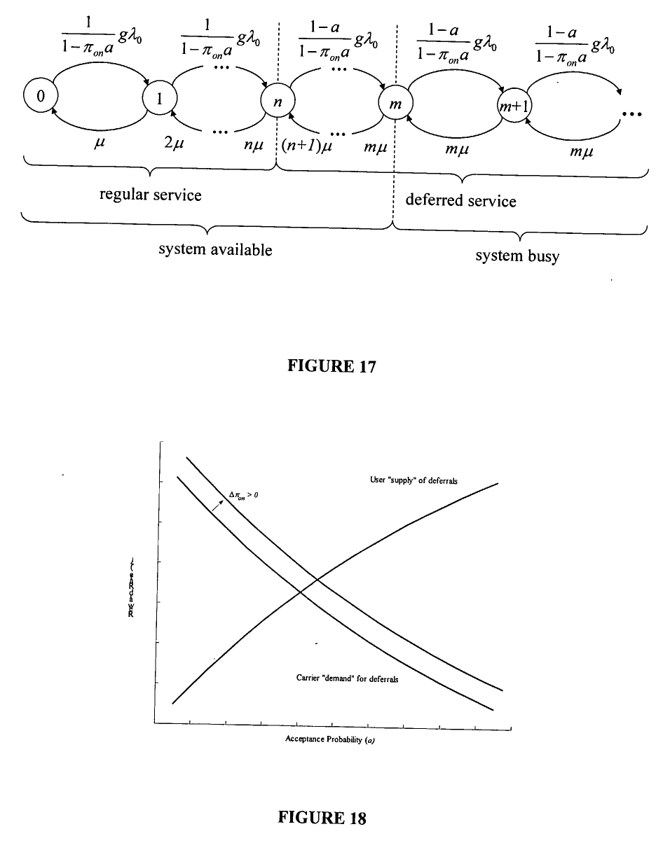

To illustrate the effects of the deferred service regime we begin by considering a 25 channel antenna, modeled as a 25 server M/G/m queue. Assume the demand parameters λ₀=7.36, which yields 99% availability, i.e., at least one free server 99% of the time. Consider the deferred service queue for values of n>λ₀/μ and calculate availability for the entire range of feasible values of πₒₙ in each case. The ability to regulate availability of the deferred service queue is evident in FIG. 19

Moving from right to left in FIG. 19, the curves are calculated for n=15, 16, . . . , 25. As an example consider the right-most curve for n=15. The circle (◯) at the beginning of the curve represents the M/G/m queue (with π₁₅+π₁₆+ . . . =51%). There is a critical value of πₒₙ, roughly 60%, before which availability is improved, even while gλ₀>λ₀. Beyond the critical value of πₒₙ, the increasing load gλ₀ causes availability to decrease. As n is increased the policies can be interpreted in a similar way.

### Maximum Service Level and Maximum Throughput

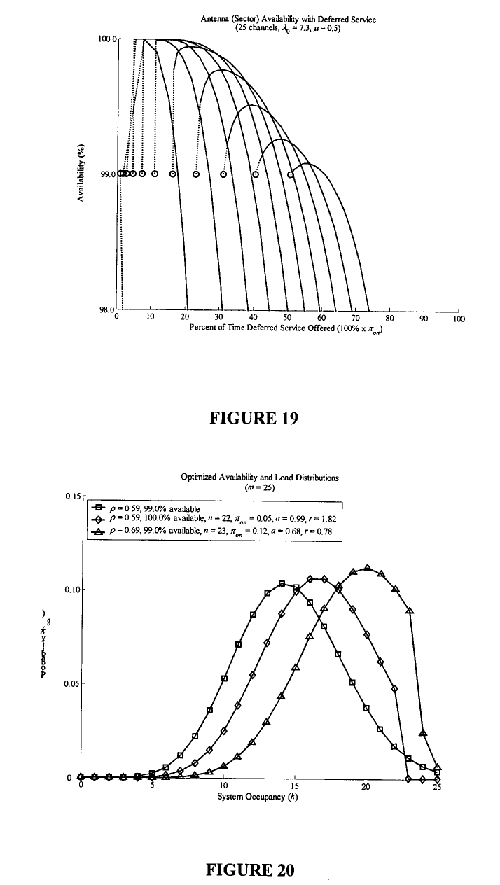

In addition to the range of potential performance shown in FIG. 19, another instructive illustration comes from considering the full queue distribution. Consider the same 25 channel antenna model as above (again with 99% initial availability). The policies and distributions that maximize availability and service throughput are illustrated in FIG. 20.

Note that the award r and the acceptance probability a are both lower in the maximum throughput distribution of FIG. 20, so that λ₀=ρmμ. Both distributions show a noticeable shift to the right and a kink at occupancy given by n, where probabilities begin to sharply decrease due to the reduced entry of connections into the system.

### Effects

The queuing analysis and numerical example of a cellular antenna above shows the revenue management scheme can be designed for a given performance target to either improve performance (increasing availability also increases quality) and/or increase carrying capacity and/or both. For the example calculating g from the example above, with a target blocking performance of 1%, the potential improvement in antenna throughput (in minutes) ranges form 10% -26%. The former improvement results from g, the latter is given by (g*(0.69/0.59)−1), which captures increases in throughput per Erlang of demand (g) as well as Erlangs of demand (λ₀/μ).

The application server monitors demand (arrival rate), length of callas (average service time) and occupancy of the system or subsystem (antenna, group of antennas, or any amount of capacity designated) being managed. The application server also calculates the award currently being offered, if occupancy is sufficiently high, according to the mathematical equations outline in the previous embodiment. Online sampling and estimation techniques are likely to be implemented in the application server. The application server may query the database for certain information in estimating quantities defined in the previous embodiment.

The database stores information on a transaction by transaction basis for users of the system. The data stored may include, but is not necessarily limited to: unique device or user ID (e.g. phone number or serial number), system or subsystem ID (tower ID, IP address of a portion of a network, or any other network addressing scheme), time of a transaction, type of transaction (e.g. dialed call, incoming call, etc.), amount of award offered to the user, user decision (accept or reject the award offer or void a previously accepted award), period of time use is deferred (if accepted), duration of a completed call, etc.

The invention can operate with compensation other than free minutes of service, i.e. monetary or other product/service awards. Specifically digital music is suggested as a good award product. Other awards may also be possible. In the case of an award other than free service the previous embodiments are essentially unchanged except for the consideration for the user decision and the quantity of traffic in the queuing model. Free service disappears from the queuing model above through setting r=0. The resulting effect on the available increase in throughput can only increase and can be calculated using the above formulae eliminating all mathematical terms that include r

The user choice model can be altered by changing

(1−c)ν+k≦rE[V|ν>p(gλ₀)] to (1−c)ν+k≦x,

where x is the value of the award service, e.g. 99¢ is a typical value for a digital recording of a popular song. The subsequent substitutions are

$$\begin{matrix}a = P [ v < \frac{rE [ V \vert v > p ( g {λ}_{0} ) ] - k}{1 - c} \vert v \geq p ( g {λ}_{0} ) ] to a \\ = P [ v < \frac{x - k}{1 - c} \vert v \geq p ( g {λ}_{0} ) ] \\ {v}^{*} = \frac{rE [ V \vert ( g , {p}_{0} ) ] - k}{( 1 - c )} \geq p ( g {λ}_{0} ) to {v}^{*} = \frac{x - k}{( 1 - c )} \geq p ( g {λ}_{0} ) .\end{matrix}$$

The method can now be applied with other award quantities.

It is obvious that the foregoing embodiments of the invention are exemplary and can be varied in many ways. Such present or future variations are not to be regarded as a departure from the spirit and scope of the invention, and all such modifications as would be obvious to one skilled in the art are intended to be included within the scope of the following claims.

I claim:

1. A system for managing use and access to a communication network or service, said system comprising:
a) one or more user devices adapted for connection to the communication network or service, each of said user devices having a deferral management system installed thereon, each said deferral management system for regulating and controlling access to the communication network or service by a respective user device; and
b) a deferral assessment system adapted for evaluating usage of the communication network or service, said deferral assessment system for generating access data reflective of the usage of the communication network or service;
wherein said deferral management system regulates and controls access of the respective user device to the communication network or service in response to the access data.

2. A method of communication network access comprising the steps of:
a) offering a subscriber attempting access to the network a reward for deferring access by a predetermined delay;
b) providing the award on acceptance by the subscriber; and
c) accepting access from the subscriber after at least the predetermined delay.

3. A method of communication network access comprising the step of:
a) establishing an access queue having current access and deferred access subscribers.

4. A method of accessing a communication network comprising the steps of:
a) establishing pools of subscribers having current access and deferred access;
b) offering a subscriber attempting access to the network a reward for deferring access by a predetermined delay;
c) providing the award on acceptance by the subscriber; and
d) accepting access from the subscriber after at least the predetermined delay.

5. Apparatus for communication network access comprising:
a) means for offering a subscriber attempting access to the network a reward for deferring access by a predetermined delay;
b) means for providing the award on acceptance by the subscriber; and
c) means for accepting access from the subscriber after at least the predetermined delay.

6. Apparatus for communication network access comprising:
a) means for establishing an access queue having current access and deferred access subscribers.

7. Apparatus for accessing a communication network comprising:
a) means for establishing pools of subscribers having current access and deferred access;
b) means for offering a subscriber attempting access to the network a reward for deferring access by a predetermined delay;
c) means for providing the award on acceptance by the subscriber; and
d) means for accepting access from the subscriber after at least the predetermined delay.

8. A computer readable medium having recorded thereon statement and instructions for execution by a computer to carry out the method including the steps of:
a) offering a subscriber attempting access to the network a reward for deferring access by a predetermined delay;
b) providing the award on acceptance by the subscriber; and
c) accepting access from the subscriber after at least the predetermined delay.

9. A computer readable medium having recorded thereon statement and instructions for execution by a computer to carry out the method including the steps of:
a) establishing an access queue having current access and deferred access subscribers.

10. A computer readable medium having recorded thereon statement and instructions for execution by a computer to carry out the method including the steps of:
a) establishing pools of subscribers having current access and deferred access;
b) offering a subscriber attempting access to the network a reward for deferring access by a predetermined delay;
c) providing the award on acceptance by the subscriber; and
d) accepting access from the subscriber after at least the predetermined delay.
